(19) United States
(12) Patent Application Publication
(10) Pub. No.: US 2026/0318887 A1
(43) Pub. Date: Oct. 15, 2026

(54) LOW-PRESSURE CAPILLARY EXTRACTION SYSTEMS AND METHODS FOR GCMS ANALYSIS

(71) Applicant: Entech Instruments Inc., Simi Valley, CA (US)

(72) Inventor: Daniel B. CARDIN, Simi Valley, CA (US)

(21) Appl. No.: 19/648,922

(22) Filed: Apr. 15, 2026

Related U.S. Application Data
(60) Provisional application No. 63/789,291, filed on Apr. 15, 2025.
(60) Provisional application No. 63/789,200, filed on Apr. 15, 2025.

(51) Int. Cl. G01N 30/72; G01N 1/40; G01N 1/44; G01N 30/06

(52) U.S. Cl. CPC G01N 30/7206; G01N 1/405; G01N 1/44; G01N 30/06

(57) ABSTRACT

In some embodiments, a gas manifold prepares a pressurized reservoir including metered gas-phase internal standards and calibration standards based on monitored partial pressures. The reservoir delivers pressurized gas to a vial interface having a gas inlet needle and a liquid outlet needle to transfer substantially all vial contents to a sparge vessel while maintaining fluid communication to extract volatiles remaining in the vial. The sparge vessel can be operated under reduced pressure and can include heating and a downstream cold section to reduce the amount of moisture contained in the sparge gas. In some embodiments, a liquid or solid sample is provided in a sample vial for headspace analysis. Extracted analytes are retained on a staged multi-capillary primary trap, optionally transferred to a staged focusing trap, and injected to a GCMS using carrier gas.

### CROSS-REFERENCE TO RELATED APPLICATIONS

This application claims the benefit of U.S. Provisional Application No. 63/789,291, filed Apr. 15, 2025, and U.S. Provisional Application No. 63/789,200, filed Apr. 15, 2025, the contents of which are incorporated herein by reference in their entireties for all purposes.

### FIELD

The present disclosure relates to sample preparation systems and methods for gas chromatography and gas chromatography/mass spectrometry (GCMS) analysis, including configurations for transferring volatile compounds from sealed sample vials under reduced pressure and concentrating the volatile compounds for injection to a GCMS while reducing moisture and solvent contributions.

### BACKGROUND

Volatile organic compounds in water are commonly analyzed using purge-and-trap in which the sample is purged with a gas and the purged analytes are collected on a sorbent trap and then desorbed for GCMS analysis. While such techniques are widely used, they frequently employ relatively small sample volumes and often rely on packed traps and split injection during desorption. In some implementations, splitting is used to achieve suitable injection rates and peak widths for capillary GC columns, and to reduce the amount of water introduced into the GCMS, at the cost of reduced sensitivity.

Water introduced into a GCMS can present a number of operational challenges. For example, water can adversely affect column performance, contribute to increased column bleed, and increase maintenance requirements associated with contamination of MS components. In addition, as mass spectrometers have become more sensitive, the tolerance for co-injected water usually decreases due to a loss in ionization efficiency of target compounds and loss of vacuum in the MS, thereby leading to a need for higher split ratios that in turn cancel any benefits otherwise achieved using high sensitivity MS instrumentation.

Another issue can arise from the use of liquid-phase standards, such as methanolic solutions used for internal standards and calibration standards. In virtually all purge-and-trap workflows, these standards are introduced by syringe injection in volumes that can be difficult to reduce while maintaining reliable metering. Methanol introduced with the standards can produce a large solvent peak and can suppress MS response for compounds eluting within or near the solvent peak. As a result, splitting has commonly been used to reduce solvent effects, which can further decrease the amount of analyte delivered to the GCMS.

Headspace-based approaches can reduce contact between the trap and the sample matrix, and some headspace techniques add salt to increase the transfer efficiency of VOCs into the headspace while slightly reducing the concentration of water vapor in the headspace in an attempt to improve on sensitivity and analytical consistency relative to purge-and-trap. However, recovery of VOCs out of the water compared to purge-and-trap have not been as efficient, so to date the most sensitive means for analyzing VOCs in water remains purge-and-trap. Unfortunately, due to the need to perform large split injections to eliminate water and excess Methanol, purge-and-trap has not kept up with other analytical techniques that can measure non-VOC contaminants in water at far lower concentrations, so a more sensitive solution for measuring VOCs in water is needed.

### SUMMARY

The present disclosure relates to sample preparation systems and methods for gas chromatography and gas chromatography/mass spectrometry (GCMS) analysis, including configurations for transferring volatile compounds from sealed sample vials under reduced pressure and concentrating the volatile compounds for injection to a GCMS while reducing moisture and solvent contributions. Some examples relate to concentrating volatile compounds from aqueous samples contained in sealed vials, adding internal standards and calibration standards, managing water and solvent contributions presented to an analytical instrument, and transferring the concentrated analytes for injection to a GCMS.

In some embodiments, a sample-preparation system is configured to concentrate volatile compounds from a sealed sample vial for subsequent gas chromatography/mass spectrometry (GCMS) analysis while reducing delivery of moisture and solvent to the GCMS. The system may accept a sealed vial, pierce a septum with a gas inlet needle and a liquid outlet needle, and deliver pressurized gas into the vial to transfer liquid from the vial into a sparge vessel while maintaining the vial in fluid communication with the extraction flow path so that volatile compounds remaining in the vial can continue to outgas during extraction.

In some embodiments, the system includes a gas manifold configured to prepare a pressurized reservoir comprising a combination of gas streams. The reservoir may be evacuated and, as needed, may be rinsed by adding a purge gas and evacuating again. The manifold may include valves and flow restrictors to supply a low-flow purge gas and to supply one or more gas-phase standards, and the reservoir may include a pressure sensor configured to measure pressure and/or partial pressure to enable repeatable metering of internal standard additions and calibration standard additions.

In some embodiments, the pressurized reservoir is coupled to the vial through an isolation valve so that reservoir gas, including metered standards, can be admitted into the vial to drive substantially all of the vial contents into the sparge vessel. Completion of liquid transfer may be detected by a pressure change measured by the pressure sensor when a liquid level in the vial drops below the liquid outlet needle and gas begins to flow through the liquid outlet needle.

In some embodiments, after and/or during transfer, the sparge vessel and at least a portion of a connected flow path are operated under reduced pressure to speed extraction rates by decreasing the residence time of gas molecules in the sparge vessel resulting in faster delivery to the trap. Vacuum may be applied using an evacuated volume measurement reservoir and a vacuum pump, and purging may be performed at a vacuum level of about 1 to 4 psi absolute while a low-flow purge gas continues to sweep the sparge vessel toward one or more traps. A stream select valve may be operated to direct sparger outlet flow toward a primary trap during transfer and/or during vacuum-assisted sparging.

In some embodiments, the system includes a primary capillary trap comprising multiple sections of open tubular capillary columns having increasing sorbent strength. The primary trap may include temperature control, including a heater and a fan or blower, to maintain conditions that limit the amount of moisture reaching the trap by reducing the dew point, thereby reducing the concentration of water in the gas phase prior to exiting the sparge vessel. In some implementations, after trapping, a dry gas is routed through the primary trap to remove water vapor.

In some embodiments, trapped analytes are transferred from the primary trap to a secondary focusing trap by backflushing and heating the primary trap while flowing a desorb gas. The focusing trap may comprise multiple capillary column segments of increasing sorbent strength that are shorter than corresponding segments of the primary trap to concentrate analytes for rapid injection to a GCMS with splitless or near-splitless operation. The focusing trap may be preheated to increase injection rate, and a GC carrier gas may sweep released analytes into the GCMS.

In some embodiments, a volume measurement reservoir is connected downstream of the primary trap and is used to monitor volume based on pressure changes, including monitoring volume passed during sparging and/or volatile compound transfer. The volume measurement reservoir can also monitor volume used during transfer from the primary trap to the focusing trap. The volume measurement reservoir may be re-evacuated using a pump.

In some embodiments, the system is operable in a mode for higher concentration samples in which the focusing trap is bypassed and the primary trap is desorbed using GC carrier gas with a split injection, optionally using a GC injector split or a dedicated split port. In some embodiments, the system is operable to analyze a vial having substantial initial headspace, including configurations in which a low liquid volume remains in the vial, by transferring liquid to the sparge vessel while also sweeping headspace through the sparge vessel and toward the primary trap such that compounds partitioned into the vial headspace are not lost. In some cases for even higher concentration samples, a small volume of liquid sample can be transferred to another vial to perform up to 1000:1 dilution prior to performing an extraction, again with direct split injection from the primary trap to the GCMS.

In some embodiments, a vacuum headspace extraction system is configured for liquid and/or solid samples to use volatilized matrix vapor as a carrier gas under vacuum. A sample vial may be pneumatically connected via a leak-tight seal to a short transfer line and vacuum may be applied to create sufficiently low pressure on the sample so that vapor from the matrix sweeps volatile analytes to a staged primary capillary trap without introducing a separate purge gas to the sample vial. Example implementations further include drying the primary trap with a purge gas after extraction and either desorbing directly to the GCMS with split injection or desorbing to a focusing trap for splitless or low-split injection, including configurations that control peak width using pressure-controlled splitting.

In some implementations, the vacuum headspace extraction system operates in a time-under-vacuum mode when headspace volume is limited, including opening an evacuation path and a flow control path to maximize vacuum at the sample vial. In some implementations, sample temperature is controlled to increase matrix vapor pressure and improve the consistency of volatile analyte recovery from sample to sample. A vacuum pump creates a pressure drop along the flow path such that water vapor concentrations can be maintained below their condensation point even when the trap is at a similar temperature to, or a lower temperature than, the sample. In some implementations, automation introduces a final purge through the transfer line to push heavier compounds toward the primary trap and/or moves the transfer line to a vacuum source to vacuum-clean between samples to reduce carryover. In other implementations, transfer tubing may be held at a lower temperature than the sample matrix to partially condense water to reduce the impact on the trap.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The present disclosure is illustrated by way of example, and not by way of limitation, in the figures of the accompanying drawings and in which like reference numerals refer to similar elements.

FIG. 1A illustrates an example system that transfers an aqueous sample from a sealed vial to a sparge vessel and delivers extracted volatile compounds to a GCMS while limiting moisture and solvent transfer.

FIG. 1B illustrates an example water transfer zone and sparger apparatus that interfaces with a sealed sample vial to transfer liquid into a sparge vessel, to apply thermal conditioning that includes heating a liquid matrix and cooling an exiting gas stream, and to support post-extraction liquid removal and evacuation of the sparger volume.

FIG. 2 is a flow chart of an example method for low-pressure capillary extraction of volatile compounds from a sealed sample vial and delivery of the extracted analytes to a GCMS system.

FIG. 3 is an example vacuum solid phase incremental capillary extraction (V-SPICE) sample-preparation system that is operable to transfer volatile compounds from a sample under reduced pressure to a staged multi-capillary column primary trap, and to transfer collected analytes for injection to a GCMS.

FIG. 4 is a flow chart illustrating an example method for extracting volatile analytes from a sample contained in a vial and delivering the analytes for analysis by a gas chromatograph and mass spectrometer.

### DETAILED DESCRIPTION

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting.

There is a need for sample-preparation systems and methods that can process sealed sample vials, increase the amount of sample effectively analyzed, provide repeatable and low-solvent standard additions, and reduce the amount of water delivered to the GCMS while enabling rapid transfer and injection of concentrated analytes. There is also a need for techniques that can operate under reduced pressure to accelerate transfer of volatile compounds, while maintaining suitable humidity conditions along a trapping flow path to reduce condensation and preserve trap performance.

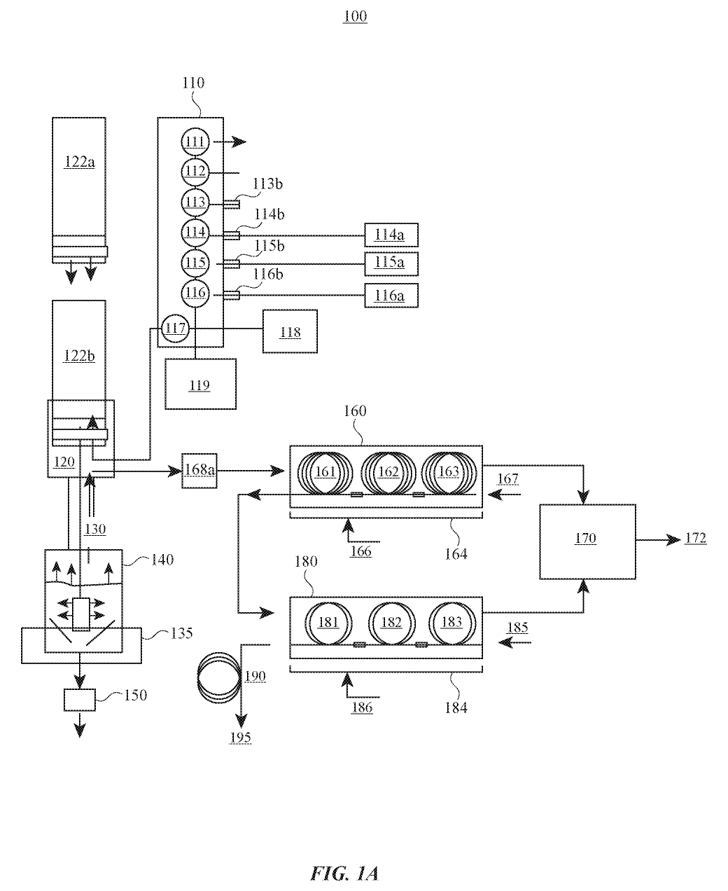

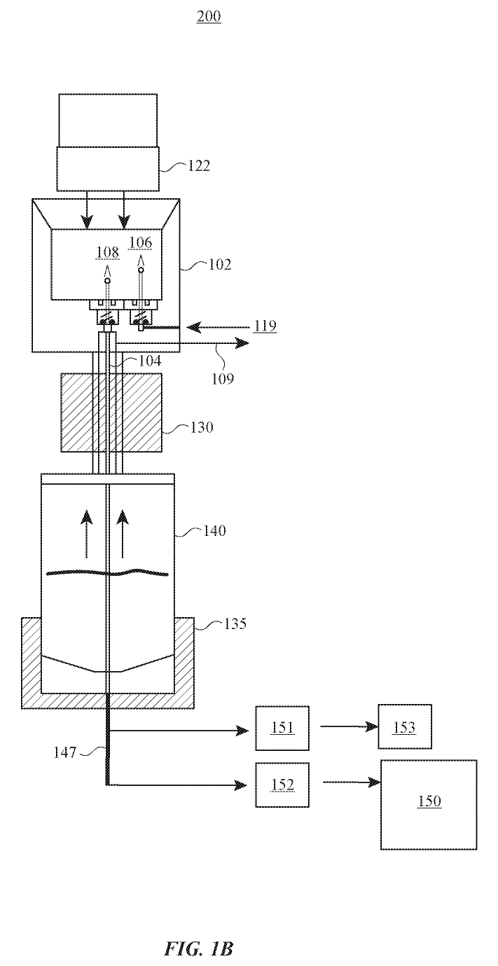

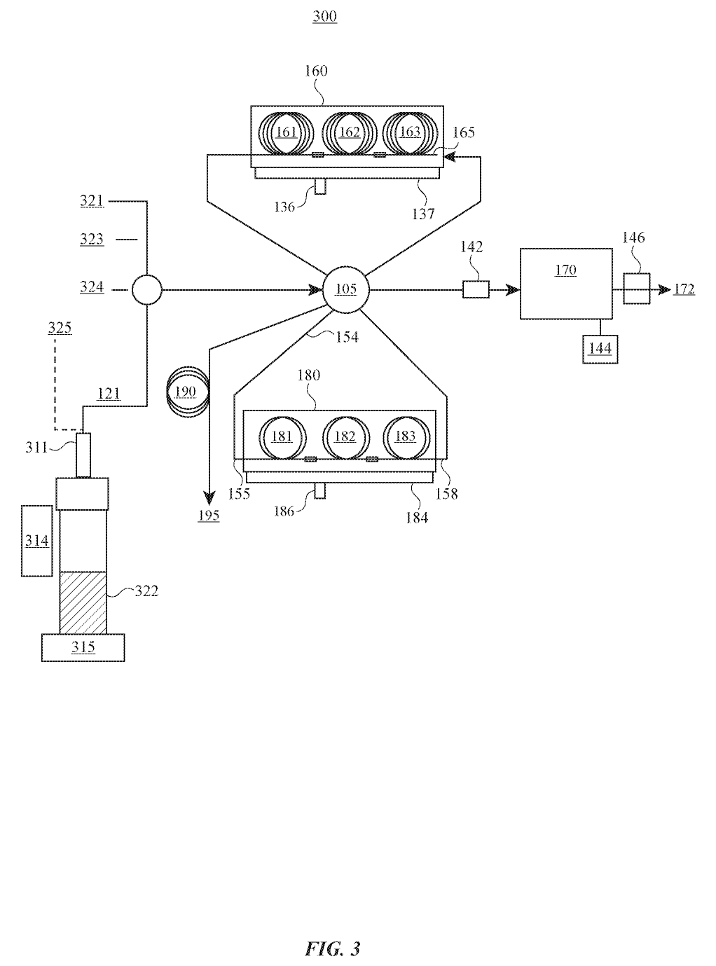

FIG. 1A illustrates an example system that transfers an aqueous sample from a sealed vial to a sparge vessel and delivers extracted volatile compounds to a GCMS while limiting moisture and solvent transfer. In some embodiments, gas manifold 110 is configured to prepare, in spike reservoir 119, a pressurized gas charge including one or more of a purge gas, an internal standard, and one or more calibration standards. Transfer port 120 is configured to receive sample vial 122a and to retain sample vial 122b during septum piercing and transfer. Sparge vessel 140 is configured to receive liquid displaced from sample vial 122b and to provide an outlet flow deliverable toward a trapping flow path. The trapping and injection flow path may include optional stream select valve 168a, multi-capillary column primary trap 160, multi-capillary column focusing trap 180, volume measurement reservoir 170, and vacuum pump 172. In some embodiments, the system includes a rotary valve similar to rotary valve 105 described with reference to FIG. 3 and/or one or more other valves to control the flow of gas in the system, with or without the use of optional stream select valve 168a. Pressure sensor 118 is fluidly coupled to spike reservoir 119 to provide pressure information used for control of metered additions and for transfer-state detection. Isolation valve 117 controls communication between spike reservoir 119 and transfer port 120.

In some embodiments, gas manifold 110 includes selectable inlets that deliver gases into spike reservoir 119 and that support evacuation, rinse, and preparation of a gas charge that includes internal standards and calibration standards. Vacuum valve 111 is coupled to gas manifold 110 to evacuate spike reservoir 119 prior to preparing a charge and to support removal of residual gases between runs. High-flow nitrogen purge valve 112 is coupled to gas manifold 110 to flow nitrogen into spike reservoir 119 for rinse operations. Low-flow nitrogen purge valve 113 is coupled to gas manifold 110 through nitrogen restrictor 113b, with nitrogen restrictor 113b configured to set a flow impedance that supports a lower flow rate of nitrogen into spike reservoir 119 for pressurization and subsequent delivery into sample vial 122b. Additionally, pressure sensor 118 is positioned to sense pressure in spike reservoir 119 during evacuation, gas additions, and pressurization, and the sensed pressure is usable to compute or infer partial pressures associated with added gas streams.

In some embodiments, gas manifold 110 is configured to meter an internal standard and one or more calibration standards into spike reservoir 119 as gas-phase additions that reduce introduction of liquid solvent into the extraction flow path. A gas phase standard can be prepared from high concentration Methanolic standards such that very little Methanol is added to the gas canister prior to pressurization. This can reduce the effective amount of Methanol added to each analysis from 1-5ul as is typical with purge-and-trap that performs liquid standard injections, to less than 0.002ul of liquid equivalent Methanol introduced using gas phase standards. Internal standard valve 114 is coupled between internal standard gas canister 114a and spike reservoir 119, and internal standard restrictor 114b is disposed along a flow path between internal standard valve 114 and spike reservoir 119 to set a flow impedance that supports controlled filling. Low calibration standard valve 115 is coupled between low calibration standard gas canister 115a and spike reservoir 119, and low calibration standard restrictor 115b is disposed along the corresponding flow path to support metering. High calibration standard valve 116 is coupled between high calibration standard gas canister 116a and spike reservoir 119, and high calibration standard restrictor 116b is disposed along the corresponding flow path. Including both a low calibration standard and a high calibration standard in gas manifold 110 enables calibration curves over a factor of 1000x or more. The use of internal standard in each analysis means there is less volume available for calibration standard, so having two calibration standards with concertation differences of roughly 100 times facilitates appropriate concentration and volume of calibration standard in each analysis. In this configuration, pressure sensor 118 provides, for each selected valve 114, 115, 116, a pressure indication during filling that supports control of a target partial pressure contribution from internal standard gas canister 114a, low calibration standard gas canister 115a, and/or high calibration standard gas canister 116a in spike reservoir 119, and low-flow nitrogen purge valve 113 provides nitrogen to reach a target delivery pressure in spike reservoir 119.

In one aspect, spike reservoir 119 is coupled to transfer port 120 through isolation valve 117 such that a prepared gas charge in spike reservoir 119 is deliverable into sample vial 122b during a transfer operation. Transfer port 120 receives sample vial 122a uncoupled from the system and holds sample vial 122b coupled to the system in a position for septum piercing and fluidic coupling to a gas-in path and a liquid-out path, with the liquid-out path coupled to sparge vessel 140. During transfer, isolation valve 117 is actuated to admit pressurized gas from spike1reservoir 119 into sample vial 122b, thereby driving liquid from sample vial 122b into sparge vessel 140 while maintaining sample vial 122b in fluid communication with the extraction flow path. Additionally, pressure sensor 118 senses pressure behavior associated with transfer, including a pressure change associated with a transition from liquid displacement to gas flow through the liquid-out path when the liquid level at sample vial 122b drops below an inlet of the liquid-out path.

Sparge vessel 140 is positioned downstream of transfer port 120 to receive displaced liquid and to support generation of an outlet gas stream that carries volatile compounds toward multi-capillary column primary trap 160. Waste container 150 is coupled to sparge vessel 140 through one or more valves shown in FIG. 1B to receive collected liquid. Sparge vessel 140 is depicted with thermal conditioning elements including a cooler 130 positioned adjacent an upper region of sparge vessel 140 and a heater 135 positioned adjacent a lower region of sparge vessel 140 to influence water vapor content and analyte transfer kinetics in an exiting stream. Heater 135 rapidly transfers volatile compounds to the gas phase and enables faster removal of residual compounds during bakeout after the water has been removed from sparge vessel 140. Furthermore, optional stream select valve 168a is fluidly coupled to sparge vessel 140 and is configured to select a flow path direction for gas exiting sparge vessel 140, including routing an exiting stream toward multi-capillary column primary trap 160 during transfer and extraction and routing one or more gases during conditioning, purge, or desorb operations. Optional stream select valve 168a allows other gas or calibration streams to be added, but may be omitted if such additions are not needed.

In some embodiments, multi-capillary column primary trap 160 is positioned downstream of optional stream select valve 168a. Multi-capillary column primary trap 160 is configured to retain a volatility range of compounds on staged open tubular capillary column sections having different sorbent retention strengths. Weak capillary column section 161 is disposed upstream of moderate capillary column section 162, and moderate capillary column section 162 is disposed upstream of strong capillary column section 163, such that a sample stream entering multi-capillary column primary trap 160 is exposed sequentially to sorbents of increasing retention strength. Primary trap heater 164 is thermally coupled to multi-capillary column primary trap 160 to control trap temperature during trapping and desorption modes, and primary trap cool-down fan or blower 166 may be positioned to convectively remove heat from multi-capillary column primary trap 160 to support temperature transitions and control of moisture behavior. Additionally, valve 167 is arranged to permit introduction of desorb gas to multi-capillary column primary trap 160 during a reverse-flow desorption mode in which collected analytes are mobilized from the capillary column sections 161 through 163 for transfer downstream.

In one aspect, volume measurement reservoir 170 and vacuum pump 172 cooperate with the trapping flow path to provide reduced-pressure operation and to provide volume-related information based on a measured pressure response. Volume measurement reservoir 170 is fluidly coupled relative to multi-capillary column primary trap 160 such that gases passing through the trap are collectable in volume measurement reservoir 170 for pressure-based monitoring, and vacuum pump 172 is coupled to volume measurement reservoir 170 to evacuate volume measurement reservoir 170 before extraction, during extraction, and between runs. In this arrangement, a pressure change in volume measurement reservoir 170 is used to infer a quantity of gas passed through the trapping path during extraction and to determine a quantity of desorb gas passed during transfer of analytes from multi-capillary column primary trap 160 toward multi-capillary column focusing trap 180. Additionally, the reduced pressure applied through volume measurement reservoir 170 and vacuum pump 172 supports extraction under sub-atmospheric conditions in sparge vessel 140 and in associated volumes coupled to transfer port 120. The vacuum applied by vacuum pump 172 is strongest at multi-capillary column primary trap 160 to reduce the potential for moisture condensation in the multi-capillary column primary trap 160. The vacuum is a gradient through the flow path, and is most strong at an outlet of the multi-capillary column primary trap 160 to which vacuum pump 172 is coupled through volume measurement reservoir 170, then the inlet of multi-capillary column primary trap 160, then sparge vessel 140, then sample vial 122b.

In some embodiments, multi-capillary column focusing trap 180 is positioned downstream of multi-capillary column primary trap 160 and is configured to receive analytes desorbed from multi-capillary column primary trap 160 for band focusing prior to injection to the gas chromatograph. Multi-capillary column focusing trap 180 includes weak focusing capillary column section 181, moderate focusing capillary column section 182, and strong focusing capillary column section 183 arranged in series to provide staged retention during transfer from multi-capillary column primary trap 160. Focusing trap heater 184 is thermally coupled to multi-capillary column focusing trap 180 to support preheating and rapid release of focused analytes, and focusing trap cool-down fan or blower 186 may be positioned to remove heat from multi-capillary column focusing trap 180 to support temperature control between stages. Furthermore, GC carrier gas is coupled to multi-capillary column focusing trap 180 such that, during injection, GC carrier gas sweeps released analytes from multi-capillary column focusing trap 180 into a GC column 190 and toward an MS detector 195.

FIG. 1B illustrates an example water transfer zone and sparger apparatus that interfaces with a sealed sample vial to transfer liquid into a sparge vessel, to apply thermal conditioning that includes heating a liquid matrix and cooling an exiting gas stream, and to support post-extraction liquid removal and evacuation of the sparger volume. The apparatus includes sample vial 122 that can be positioned in water transfer zone 102, a gas inlet from spike reservoir 119 coupled to a gas inlet needle 106, a liquid outlet needle 108 coupled to a transfer tube to sparger inlet 104, and a sparge vessel 140 that provides a gas-liquid contacting region for transferring volatile compounds into an outlet stream deliverable through sparger outlet 109. The sparge vessel 140 includes heater 135 thermally coupled to a lower region of sparge vessel 140, cooler 130 positioned upstream of sparger outlet 109 to reduce moisture carried toward sparger outlet 109. Sparger outlet 109 is coupled to trapping portions of the rest of the system, such as to multi-capillary column primary trap 160 illustrated in FIG. 1A. Additionally, sparger drain/outlet line 147 is coupled to drain valve 152 for discharge to waste container 150, and sparger drain/outlet line 147 is coupled through vacuum valve 151 to vacuum pump 153 to draw reduced pressure on sparge vessel 140 once the water has been removed from sparge vessel 140.

Water transfer zone 102 forms a septum-piercing interface for sample vial 122 that supports dual-needle transfer with separate gas pressurization and liquid outlet paths. Gas inlet needle 106 is disposed to pierce a septum of sample vial 122 and is fluidly coupled to gas inlet from spike reservoir 119 such that a pressurized gas charge dispensed from spike reservoir 119 is introduced into a headspace region of sample vial 122 to develop a driving pressure for liquid transfer. Liquid outlet needle 108 is disposed to pierce the septum of sample vial 122 and is fluidly coupled to transfer tube to sparger inlet 104 such that sample liquid displaced from sample vial 122 flows out through liquid outlet needle 108 and progresses toward sparge vessel 140. In this configuration, the respective placements of gas inlet needle 106 and liquid outlet needle 108 establish a transfer geometry in which pressure applied via gas inlet from spike reservoir 119 drives liquid transfer while maintaining sample vial 122 in fluid communication through water transfer zone 102 during subsequent sweep and extraction operations.

In some embodiments, sparge vessel 140 receives liquid delivered via transfer tube to sparger inlet 104 and supports volatilization of analytes into an exiting gas stream delivered toward sparger outlet 109. A plate having 10-16 holes arranged around the edges is disposed between sparge vessel 140 and bottom tubing to generate bubbles along the outer wall of the sparge vessel 140. The bubble generation increases interfacial area between the liquid and the gas phase within sparge vessel 140, and the upward motion of bubbles creates mixing within the liquid phase to promote mass transfer of volatile compounds into the gas stream. The outer wall of sparge vessel 140 makes contact with heater 135, causing warmer water to rise along the outer wall of the sparge vessel 140, cool at the top surface due to evaporation, and for cooler water to sink in sparge vessel 140 towards the middle of sparge vessel 140. Furthermore, sparger outlet 109 is coupled to an upper region of sparge vessel 140 such that the gas stream exiting the vessel carries extracted analytes toward a downstream trap assembly described with respect to FIG. 1A.

Cooler 130 and associated thermal conditioning elements are arranged to manage moisture and aerosol transport in the stream presented to sparger outlet 109 while supporting analyte release from the liquid phase in sparge vessel 140. Heater 135 is positioned adjacent a lower region of sparge vessel 140 to transfer heat into the liquid, thereby increasing vapor-phase driving forces for compounds with lower volatility. Cooler 130 is disposed upstream of sparger outlet 109 along the gas path such that the gas stream rises from the liquid surface into a cooled region prior to entering sparger outlet 109. Cooler 130 removes heat from the gas stream and promotes condensation and coalescence of entrained droplets and/or aerosols, which reduces the amount of water conveyed to the sparger outlet 109 and to downstream multi-capillary column primary trap 160. Additionally, the serial arrangement of heater 135 and cooler 130 conditions the gas stream with a temperature gradient that supports volatilization in sparge vessel 140 while providing moisture control upstream of sparger outlet 109.

Sparger drain/outlet line 147 provides a controlled discharge pathway for removal of liquid remaining in sparge vessel 140 after extraction and a controllable evacuation pathway for applying vacuum to sparge vessel 140. Drain valve 152 is disposed along sparger drain/outlet line 147 and is selectively actuatable to place an interior volume of sparge vessel 140 in fluid communication with waste container 150, such that liquid is driven out of sparge vessel 140 through sparger drain/outlet line 147 during a draining mode. Vacuum valve 151 is disposed along a vacuum branch coupled to sparger drain/outlet line 147 and is selectively actuatable to place sparge vessel 140 in fluid communication with vacuum pump 153, thereby drawing reduced pressure on sparge vessel 140 during an evacuation mode. Furthermore, actuation of vacuum valve 151 and vacuum pump 153 supports removal of residual vapor from sparge vessel 140 following drainage through drain valve 152 and supports coordination with upstream pressurization in water transfer zone 102 and downstream trapping via sparger outlet 109.

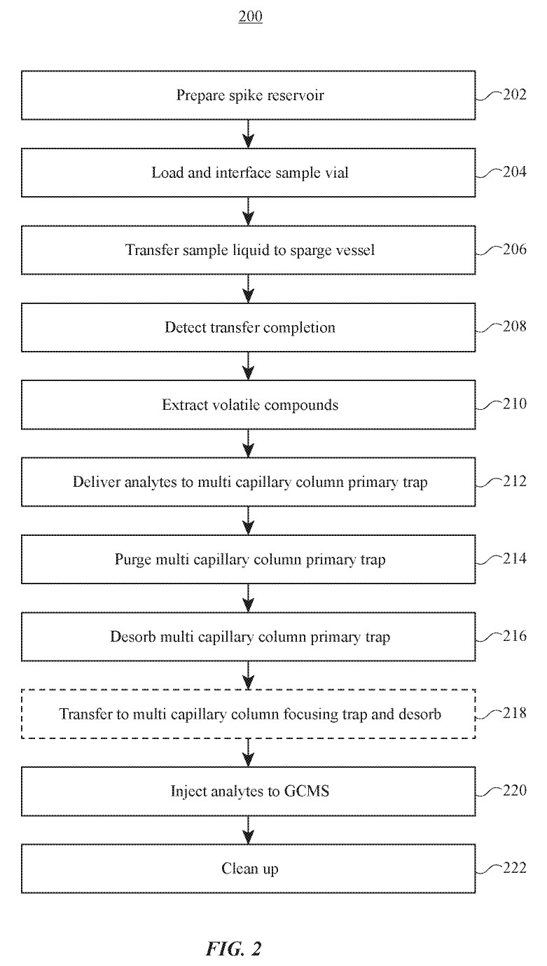

FIG. 2 is a flow chart of an example method 200 for low-pressure capillary extraction of volatile compounds from a sealed sample vial and delivery of the extracted analytes to a GCMS system. The system illustrated in FIGS. 1A-1B performs the method 200 illustrated in FIG. 2.

Method 200 includes preparing spike reservoir 119 (202). The spike reservoir 119 may be evacuated via vacuum valve 111 to reduce residual gases in the spike reservoir 119 prior to preparing a pressurized gas charge. Preparing the spike reservoir 119 (202) includes metering one or more gas-phase standards into the spike reservoir 119 by opening one or more of internal standard valve 114, low calibration standard valve 115, and high calibration standard valve 116. Corresponding restrictors 114b, 115b, and 116b provide flow impedance to support controlled filling, and pressure sensor 118 provides a pressure indication usable to reach a target partial pressure contribution for each admitted standard. Preparing the spike reservoir 119 (202) includes bringing the spike reservoir 119 to a target delivery pressure. A purge gas may be admitted to the spike reservoir 119, such as via low-flow nitrogen purge valve 113 and nitrogen restrictor 113b, to bring the spike reservoir 119 to a target delivery pressure for subsequent sample transfer. Ensuring adequate pressure in spike reservoir 119 increases the speed of transferring the water to sparge vessel 140. The amounts of internal standard, low calibration standard, and high calibration standard are selected to generate a calibration curve and to track the absolute sensitivity of the MS detector 195.

Method 200 includes loading and interfacing sample vial 122a (204). Sealed sample vial 122a containing an aqueous sample or an aqueous blank may be positioned in vial transfer port 120 as sample vial 122b. Loading and interfacing sample vial 122a (204) includes positioning sample vial 122b in water transfer zone 102 and piercing the septum of the sample vial 122b with gas inlet needle 106 and liquid outlet needle 108 to establish a gas admission path from gas inlet from spike reservoir 119 and a liquid discharge path to transfer tube to sparger inlet 104.

Method 200 includes transferring sample liquid to sparge vessel 140 (206). Transferring the sample liquid to the sparge vessel 140 (206) includes opening isolation valve 117 to admit pressurized gas from spike reservoir 119 to sample vial 122b to develop a driving pressure within the vial. The admitted gas drives sample liquid out of sample vial 122b through liquid outlet needle 108 and transfer tube to sparger inlet 104 into sparge vessel 140. The liquid outlet needle 108 is positioned such that, upon completion of transfer, a residual liquid layer remains in the sample vial 122b while the sample vial 122b remains in fluid communication with the extraction flow path such that volatile compounds can continue to outgas volatiles into the sparge vessel 140 to recover most to nearly all of the volatiles from the small amount of water that was not transferred in vial 122b.

Method 200 includes detecting transfer completion (208). Pressure sensor 118 may be monitored during transfer from spike reservoir 119, and a pressure behavior indicative of a transition from liquid displacement to gas flow through the liquid outlet path may be used to infer that a liquid level in the vial has dropped below a tip of the liquid outlet needle.

Method 200 includes extracting volatile compounds (210). Reducing pressure in sparge vessel 140 using volume measurement reservoir 170 and vacuum pump 172 volatilizes compounds from the liquid sample. For example, the vacuum pump 172 can lower the pressure to 0.5 psia or below during at least a portion of the sparging interval. However, during the transfer of 300cc, the pressure of the sparge vessel can increase by 3 to 3.2 psi, which would interfere with efficient vacuum extraction. Closing the valve to the spike reservoir 119, measuring the volume already sampled, re-evacuating the sparge vessel 140, then resuming extraction allows extraction to occur under lower pressure (higher vacuum). This pressure reduction can be repeated multiple times during extraction. Sparge vessel 140 generates gas-liquid contact by bubbling gas through sparger frit 141, with the resulting bubbles increasing interfacial area and mixing in the liquid held in sparge vessel 140 to promote transfer of volatile compounds to a gas phase stream deliverable through sparger outlet 109. Heater 135 heats the liquid within sparge vessel 140, and a cooling element and/or fan cools cooler 130 upstream of sparger outlet 109 prior to delivery toward a downstream trap. Extraction can occur over a period of 11 minutes in some examples.

Method 200 includes delivering analytes to multi-capillary column primary trap 160 (212). Optional stream select valve 168a, and/or one or more other valve(s), may be set to route an outlet stream from sparge vessel 140 toward multi-capillary column primary trap 160 during transfer and extraction, such that volatile compounds carried by the outlet stream are presented sequentially to weak capillary column section 161, moderate capillary column section 162, and strong capillary column section 163.

Method 200 includes purging multi-capillary column primary trap 160 (214). After trapping the analytes with multi-capillary column primary trap 160, a dry purge gas may be routed through multi-capillary column primary trap 160. Purging the multi-capillary column primary trap 160 reduces water vapor retained by the staged capillary column sections and conditions the trapping flow path for desorption. In some embodiments, primary trap temperature is controlled using primary trap heater 164 and primary trap cool-down fan or blower 166 to maintain conditions that limit condensation within multi-capillary column primary trap 160 during trapping and/or during purge.

Method 200 includes desorbing multi-capillary column primary trap 160 (216). Multi-capillary column primary trap 160 may be heated using primary trap heater 164 and backflushed with desorb gas in a direction from strong capillary column 163 towards weak capillary column 161 to mobilize analytes retained on the staged capillary column sections 161 through 163. In some embodiments, the desorption temperature is in a range from about 120 ° C. to about 180 °C.

Method 200 optionally includes transferring analytes to multi-capillary column focusing trap 180 and desorbing the multi-capillary column focusing trap (218). In some embodiments, analytes desorbed from multi-capillary column primary trap 160 are transferred to multi-capillary column focusing trap 180. Volume measurement reservoir 170 monitors a transferred volume based on a pressure change while performing the transfer from multi-capillary column primary trap 160 to multi-capillary column focusing trap 180. Transfer completion is confirmed by measuring the total volume of gas that has passed through the sparge vessel 140 and the primary multi-capillary column trap 160, such as 300cc of gas, for example. Desorbing multi-capillary column focusing trap 180 includes preheating using focusing trap heater 184, and applying GC carrier gas to sweep released analytes into a GC column 190 and toward an MS detector 195.

Method 200 includes injecting analytes to GCMS (220). In some embodiments, injection is performed splitless or near-splitless as enabled by band focusing in multi-capillary column focusing trap 180. In some embodiments in which multi-capillary column focusing trap 180 is omitted, analytes are split from multi-capillary column primary trap 160 into GCMS in a 4:1 or up to a 50:1 ratio depending on the dilution needed in order to keep samples within the linear or calibrated range of the MS detector 195.

Method 200 includes cleanup 222. After extraction, remaining liquid in sparge vessel 140 is discharged through sparger drain/outlet line 147 by opening drain valve 152 to deliver the liquid to waste container 150 by pressurizing the sparge vessel 140 and/or sample vial 122 using high-flow nitrogen gas introduced with valves 112 and 117. When the pressure in the sparge vessel 140 decreases, thereby indicating that the water has been removed, valve 112 and/or 117 is turned off and vacuum valve 151 and vacuum pump 153 evacuate sparge vessel 140 while heating with heater 135 to reduce residual volatile content prior to a subsequent run. Prior to sample vial 122b removal from transfer port 120, at least a portion of the extraction flow path may be pressurized using nitrogen through valve 112 to reduce ingress of ambient air through gas inlet needle 106 and/or liquid outlet needle 108, after which the process may be repeated for a subsequent sample vial. Diffusion of room air through the needles should be minimal prior to getting the next sample into position.

It should be understood that the operations of method 200 can be performed in the order in which they were discussed with reference to FIG. 2, or in a different order. Operations may be omitted, repeated, or reordered, and additional operations may be performed, without departing from the scope of the disclosure.

The systems and methods described above with reference to FIGS. 1A-2 provide advantages over purge-and-trap configurations by enabling analysis of a larger sample volume while reducing, and in some cases eliminating, a need for split injection during delivery of analytes to a GCMS. In some embodiments, fast injections are enabled by the use of capillary traps (e.g., multi-capillary column primary trap 160 and, optionally, multi-capillary column focusing trap 180) that provide higher linear velocities and faster release characteristics as compared to packed traps, thereby supporting narrow peak widths on a capillary GC column without relying on large split flows.

The disclosed capillary trapping architecture reduces water delivered to the GCMS as compared to packed traps, including by trapping approaches that do not retain water to the same extent as packed sorbent traps and by enabling effective moisture elimination, optionally in combination with dry purging. By reducing co-injected water, the disclosed approaches may reduce water-related suppression of mass spectrometer response and may reduce column damage and column bleed associated with moisture. In some embodiments, reducing moisture transferred to the GC column enables use of non-polar columns that produce reduced bleed into the mass spectrometer, thereby reducing down-time associated with source cleaning.

Introduction of internal standards and calibration standards in the gas phase reduces the amount of methanol introduced per analysis as compared to syringe introduction of methanolic standard solutions. A canister-based gas-phase standard preparation and partial-pressure metering approach (e.g., using gas manifold 110) can reduce methanol added per run to levels substantially below those typically associated with reliable syringe injection volumes, thereby reducing a solvent peak and mitigating sensitivity losses for compounds that would otherwise elute within or near the solvent peak. For example, a mixture of calibration standards and internal standards including 2-3 microliters of a Methanolic standard can be added to a 2.5L canister, followed by pressurization up to 50 psia, resulting in about 8L total in the canister. 1cc to 50cc of this mixture is added to spike reservoir 119 during each analysis, resulting in the use of 0.018 microliters of Methanolic standard at most. This amount is equivalent to using 1 microliter of Methanolic standard with a 60:1 split. Thus, this technique using splitless injection enables less Methanol injected to the GC detector 195 than would be a case for a 30:1 split injection using purge-and-trap. In some embodiments, gas-phase standards are used to support repeatable standard additions and to increase usable calibration dynamic range, including by selectable partial-pressure additions from low-concentration and high-concentration calibration standard canisters.

The disclosed capillary traps (e.g., multi-capillary column primary trap 160 and optional multi-capillary column focusing trap 180) are desorbable at lower temperatures than packed traps, thereby enabling recovery of thermally labile compounds using desorption temperatures lower than those commonly used for packed traps. The disclosed systems and methods may be configured for ultra-trace level analysis of drinking water by combining use of the entire contents of a sealed vial, vacuum-assisted extraction, and splitless or near-splitless injection enabled by capillary trapping and optional focusing. For higher concentration samples that do not require the lowest detection limits, multi-capillary column focusing trap 180 is bypassed and the multi-capillary column primary trap 160 is desorbed using a split injection mode while still providing reduced water delivery to the GCMS compared to purge-and-trap approaches.

The disclosed systems and methods reduce sensitivity to initial headspace conditions in the vial by operating in a manner that causes both the liquid and the headspace gas in the vial to be swept through the extraction flow path, thereby reducing losses of compounds that have partitioned into the headspace. This configuration can enable analysis of partially filled vials and can provide dilution opportunities without requiring a zero-headspace vial condition.

FIG. 3 is an example vacuum solid phase incremental capillary extraction (V-SPICE) sample-preparation system that is operable to transfer volatile compounds from a sample under reduced pressure to a staged multi-capillary column primary trap, and to transfer collected analytes for injection to a GCMS. The system includes transfer line 121 for receiving a sample vial 322 and for providing a flow path for a sample-originating stream. One or more valves, such as rotary valve 105, may be fluidly coupled to transfer line 121 and to one or more additional inlets including internal standard 321, first calibration standard 323, second calibration standard 324, and purge gas 325, such that a selected inlet stream is deliverable to the trapping flow path. Additionally or alternatively, in some embodiments, the system includes one or more valves that control flow of one or more gas streams, such as a purge valve that controls the flow of purge gas 325. The selected stream is directed to multi-capillary column primary trap 160 comprising staged capillary sections including weak column 161, moderate column 162, and strong column 163 arranged in series. Primary trap outlet 165 is coupled through flow control 142 to volume measurement reservoir 170, and volume measurement reservoir 170 is coupled through evacuation valve 146 to vacuum pump 172 to establish pressure conditions for extraction and, in some modes, for pressure-based monitoring using pressure sensor 144. In some embodiments, the system further includes multi-capillary column focusing trap 180 coupled through focus transfer line 154 and focusing trap outlet 155 for delivery to a GC inlet, where GC carrier gas drives injection to GC column 190 and MS detector 195, and where focusing thermal control is provided by a focusing trap heater and and/or cool down fan or blower.

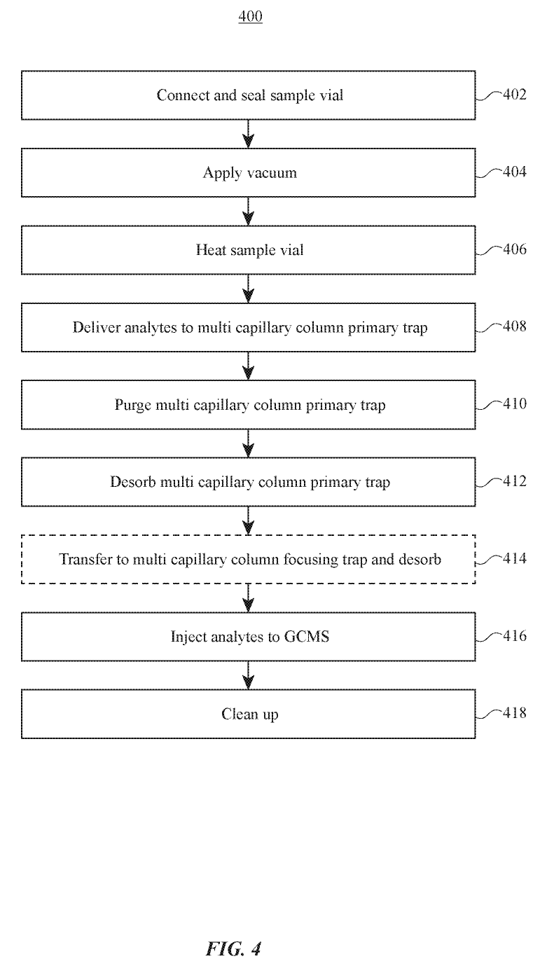

In some embodiments, transfer line 121 fluidly couples a sealed sample vial 322 to the extraction flow path while limiting exposure to ambient air. In some embodiments, the sample vial 322 is pneumatically coupled via a leak-tight seal 311, and transfer line 121 provides a short, inert flow path for headspace vapors and/or volatilized matrix vapor drawn from the sample toward primary multi-capillary column trap 160. As described in more detail below with reference to FIG. 4, transfer line 121 can be controlled by a robot. In some embodiments, a heater 315 and a fan 314 are thermally coupled to the sample vial 322 to control sample temperature and thereby influence matrix vapor pressure and analyte transfer. For example, heater 315 heats the sample vial 322 to improve evolution of the matrix into the gas phase, increase transfer speed of volatile chemicals, and increase kinetic energy to improve transmission of target compounds into the gas phase. In some embodiments, the temperature of the sample vial 122 is greater than the temperature of the multi-capillary column primary trap 160, and the multi-capillary column primary trap 160 is at a lower pressure than the sample vial 322, thereby preventing condensation in the multi-capillary column primary trap 160. In operation, transfer line 121 may connect the sample vial 322 and may also connect one or more auxiliary inlet streams for introduction to the trapping flow path before, during, and/or after an extraction interval.

One or more valves of the system selectively introduces one or more gas streams for standard addition, conditioning, and trap-drying operations. Internal standard 321, first calibration standard 323, second calibration standard 324, and purge gas 325 may be coupled to optional stream select valve 168b and/or one or more other valves as respective inlet streams to the trapping assembly. In some embodiments, the selected standard stream is introduced in a metered manner based on pressure behavior in volume measurement reservoir 170, and purge gas 125 is introduced after extraction to reduce water vapor retained in primary trap 160. In some embodiments, a temporary connection through transfer line 121 is made to sample vial 322 and other gas streams using a robotic arm to move the inlet to the other ports. In many of these cases, the calibration standards 323 and 324 and internal standard 321 are injected directly into the sample vial 322, so gas ports containing these other gas streams are not needed. This approach can further reduce the exposure to transfer lines, connectors, and plastic sealing rotors used to make seals in rotary stream select valves 168a. These additional transfer lines and plastic seals can sometime be a source of contamination, so minimizing their uses is advantageous.

Multi-capillary column primary trap 160 provides staged retention and is thermally controlled for trapping, drying, and desorption operations coordinated with the vacuum source. Multi-capillary column primary trap 160 includes weak column 161 positioned upstream of moderate column 162, and moderate column 162 positioned upstream of strong column 163, such that compounds penetrate to different depths of the staged structure based on volatility and sorbent affinity. Primary trap heater 137 is thermally coupled to multi-capillary column primary trap 160 to raise temperature for desorption and to adjust trapping conditions, while cool down fan or blower 136 is positioned to convectively remove heat to support temperature regulation. Desorb gas, at the end of the multi-capillary column primary trap 160 including strong column 163, is configured for back-desorption such that analytes collected within columns 161 through 163 are mobilized and transferred in a reverse-flow direction toward focus transfer line 154 and focusing trap 180.

Volume measurement reservoir 170 cooperates with pressure sensor 144, flow control 142, evacuation valve 146, and vacuum pump 172 to establish reduced-pressure extraction conditions and to provide pressure-based monitoring of gas transfer during desorption of the sample from sample vial 322. Flow control 142 is disposed along a flow path between primary trap outlet 165 and volume measurement reservoir 170 to set an impedance that shapes flow rate through multi-capillary column primary trap 160. Pressure sensor 144 is fluidly coupled to volume measurement reservoir 170 to provide a pressure indication that corresponds to accumulation of non-retained gases and that is usable to infer transferred volume and/or flow behavior through the trapping path. Evacuation valve 146 is coupled between volume measurement reservoir 170 and vacuum pump 172 to selectively apply vacuum to volume measurement reservoir 170 and to the upstream trapping path, including modes in which evacuation valve 146 is opened to increase vacuum on a sample coupled through transfer port 120. Additionally or alternatively, in some embodiments, extraction occurs using a time under vacuum mode described below.

In some embodiments, analytes desorbed from multi-capillary column primary trap 160 are transferred to focusing trap 180 and then injected to the GC column 190 using carrier gas while maintaining thermal control for band focusing. Desorb gas is coupled to primary trap outlet 165 and is directed through multi-capillary column primary trap 160 during a back-desorption mode to carry mobilized analytes from columns 161 through 163 through a transfer path that includes focus transfer line 154. The direction of flow while desorbing the multi-capillary column primary trap 160 is opposite the direction of flow while transferring the sample from sample vial 322 to multi-capillary column primary trap 160. Focusing trap 180 includes staged column segments including weak column 181, moderate column 182, and strong column 183 arranged in series to receive the transferred analytes and concentrate the analytes prior to GC introduction. Focusing trap heater 184 is thermally coupled to focusing trap 180 to support preheating for release, and cool down fan or blower 186 is positioned to remove heat for temperature regulation. Focusing trap outlet 155 is coupled to an injection path in which GC carrier gas sweeps released analytes into the GC inlet 158, through GC column 190, and to MS detector 195.

FIG. 4 is a flow chart illustrating an example method 400 for extracting volatile analytes from a sample contained in a vial and delivering the analytes for analysis by a gas chromatograph and mass spectrometer. The vacuum incremental capillary extraction system shown in FIG. 3 performs method 400.

Method 400 includes connecting and sealing a sample vial 322 (402). Connecting and sealing the sample vial includes pneumatically coupling sample vial 322 to leak-tight seal 311 such that a headspace region of sample vial 322 is placed in fluid communication with transfer line 121 and configuring rotary valve 105 to deliver the sample toward primary trap 160.

Method 400 includes applying a vacuum (404). Applying the vacuum (404) includes opening evacuation valve 146 using vacuum pump 172 to reduce pressure in volume measurement reservoir 170, transfer line 121, and sample vial 322. Flow control 142 sets an impedance between an outlet of multi-capillary column primary trap 160 and volume measurement reservoir 170 to influence a flow rate through primary trap 160 under the applied pressure differential.

Method 400 includes heating the sample vial 322 (406). Heater 115 increases a temperature of sample vial 322 to increase vapor pressure of a volatile matrix and to increase transport of analytes from the sample vial 322 through transfer line 121. Fan 314 influences heat transfer and stabilizes the temperature of the sample vial 322 during heating.

Method 400 includes delivering analytes to a multi-capillary column primary trap 160 (408). The analytes are delivered from sample vial 322, through transfer line 121 and rotary valve 105 to multi-capillary column primary trap 160. In some embodiments, the multi-capillary column primary trap 160 retains analytes on staged capillary columns 161, 162, and 163 as volatilized matrix vapor. Other non-retained gases pass through primary trap outlet 165 toward volume measurement reservoir 170. The increase in vacuum as the headspace travels from vial 322 through seal 311, transfer line 121, and lines delivering gases to multi-capillary column primary trap 160 causes an expansion of the gases and further separation of water molecules inside of multi-capillary column primary trap 160 relative to the headspace in vial 322, allowing the multi-capillary column primary trap 160 to be operated at slightly cooler temperatures to increase the trapping strength of the sorbents in multi-capillary column primary trap 160 without condensation of water. Sample transfer under pressurized flow paths such as in purge-and-trap do not realize a pressure drop, so trapping temperatures must be held higher than sample purge temperatures to avoid water condensation which in turn would negatively impact accuracy and overall performance of the GCMS analyzer.

Method 400 includes purging the multi-capillary column primary trap 160 (410). Purging the multi-capillary column primary trap 160 includes using a purge valve to deliver purge gas 325 through multi-capillary column primary trap 160 to reduce water vapor retained by staged capillary column sections 161 through 163. In some embodiments, operation 410 includes controlling a temperature of primary trap 160 using heater 137 and cool down fan or blower 136 to maintain conditions that inhibit condensation in the staged capillary sections thereby enabling moisture removal. In some embodiments, the purge gas is pulsed through a separate flow path into sample vial 322 to sweep heavier compounds retained in multi-capillary column primary trap 160.

Method 400 includes desorbing the multi-capillary column primary trap 160 (412). Desorbing the multi-capillary column primary trap 160 (412) includes heating primary trap 160 using heater 137 and introducing desorb gas through outlet 155 to back-desorb analytes from the staged capillary sections 161-163 in a reverse-flow direction relative to a trapping direction. Rotary valve 105 controls flow through multi-capillary column primary trap 160.

Method 400 optionally includes transferring analytes to a multi-capillary column focusing trap 180 and desorbing the focusing trap (414). Transferring analytes to multi-capillary column focusing trap 180 includes transferring analytes desorbed from primary trap 160 through focus transfer line 154 to focusing trap 180 for retention on staged segments 181-183. While desorbing the multi-capillary column primary trap 160 to transfer analytes to the multi-capillary column focusing trap 180, pressure sensor 144 monitors a pressure response in volume measurement reservoir 170 to infer transferred gas volume and/or a desorption transfer state. In some embodiments, desorbing the multi-capillary column focusing trap 180 includes preheating focusing trap 180 using focusing trap heater 157 while maintaining no-flow or reduced-flow conditions, and subsequently using a carrier gas to release focused analytes from focusing trap 180 for injection through focusing trap outlet 155. The temperatures used to desorb primary trap 160 and secondary focusing trap 180 are typically 100 ° C. lower than used to desorbed packed traps using in purge-and-trap (e.g., - 160 ° C. rather than 260 ° C.), thereby allowing recovery of more thermally labile compounds compared to purge-and-trap and other extraction techniques using packed traps to concentrate volatile compounds prior to GCMS analysis.

Method 400 includes injecting analytes to a GCMS (416). In some embodiments, analytes are transferred from multi-capillary column focusing trap 180 using GC carrier gas to sweep released analytes through a GC column 190 into an MS detector 195. In embodiments in which focusing trap 180 is omitted, analytes are injected directly from primary trap 160 using a selected split or low-split mode based on analyte abundance and target compound list, considering heavier compounds may dynamically refocus when reaching the GCMS at normal starting oven temperatures. Injection into GC column 190 and MS detector 195 is controlled with rotary valve 105.

Method 400 includes cleanup (418). Clean up 418 includes isolating sample vial 322 from the trapping flow path, evacuating one or more portions of the flow path via evacuation valve 146 and vacuum pump 172, and routing purge gas 325 through one or more components to reduce retained vapors and reduce carryover. In some embodiments, cleanup 418 further includes disconnecting sample vial 322 from leak-tight seal 311 and preparing the system for coupling to a subsequent sample vial. Gas flow during cleanup 418 is controlled with rotary valve 105.

In some embodiments, a robot controls the connection of transfer line 121. In a first configuration, transfer line 121 connects the sample vial 322 to primary multi-capillary column trap 160. For example, the first configuration is used to connect the sample vial 322 (402) and deliver analytes to the multi-capillary column primary trap 160 (408). In a second configuration, transfer line 121 connects to a vacuum port. In the second configuration, the vacuum can be turned on as part of cleanup (418) or turned off to isolate the sample via 322. Cleanup (418) further includes connecting the transfer line 121 to purge gas 325 and vacuum pump 172, bypassing the multi-capillary column primary trap 160 and optional multi-capillary column focusing trap 180.

It should be understood that the operations of method 400 can be performed in the order in which they were discussed with reference to FIG. 4, or in a different order. Operations may be omitted, repeated, or reordered, and additional operations may be performed, without departing from the scope of the disclosure.

Techniques described above with reference to FIGS. 3-4 manage moisture by leveraging a pressure gradient along the flow path to reduce condensation propensity in one or more trapping components. In particular, vacuum pump 172 may be coupled downstream of the multi-capillary column primary trap 160 such that gases evolve from a sample vial 322 and experience expansion under decreasing pressure as the gases progress toward vacuum pump 172. Under such conditions, relative humidity in multi-capillary column primary trap 160 may be maintained below 100% even when multi-capillary column primary trap 160 is maintained at approximately the same temperature as the sample vial 322, or at a lower temperature than the sample vial 322. This behavior contrasts with systems purging at a positive pressure in which the sample vial 322 and multi-capillary column primary trap 160 can be at substantially the same pressure and the multi-capillary column primary trap 160 temperature is often maintained higher than the sample temperature to reduce condensation risk. Operating multi-capillary column primary trap 160 at a higher temperature is not advantageous, as the trapping strength of sorbents are reduced as temperatures increase.

The sample vial 322 is heated while the multi-capillary column primary trap 160 is maintained cooler to retain trapping strength while maintaining condensate control via the pressure drop. For aqueous matrices, for example, reducing pressure on the sample vial 322 increases the evolution of matrix vapor and can increase the rate at which analytes are transferred toward multi-capillary column primary trap 160. The system illustrated in FIG. 3 includes temperature control at the sample vial (e.g., a heater 315 and optionally a fan 314) to increase matrix vapor pressure and to promote consistent flow behavior from sample to sample under vacuum. Fan 314 ultimately controls the dewpoint of the headspace prior to leaving the sample vial 322, and can allow heater 315 to be operated at higher temperatures to create a fluxing action within the sample vial 322 to further enhance the rate of transfer of volatile compounds to the gas phase while limiting the amount of moisture than can reach multi-capillary column primary trap 160.

In some embodiments, water is further managed by configuring the primary trap as a wall-coated capillary trap rather than a packed sorbent bed. A capillary trap can include one or more open tubular capillary columns that are wall coated with sorbent particles and that include an open interior volume. This configuration can reduce water retention relative to packed traps, due to the smaller particle size on the walls of open tubular columns that release water much more efficiently, and can enable more complete moisture removal by sweeping the trap with a drying gas after extraction. In some embodiments, the drying gas comprises nitrogen supplied after an extraction interval to purge remaining water vapor from the primary trap prior to a desorption operation.

The staged column arrangement of multi-capillary column primary trap 160 and optional multi-capillary column focusing trap 180 may reduce breakthrough of lighter compounds while allowing retention of higher-boiling compounds. Maintaining the multi-capillary column primary trap 160 at a lower temperature increases sorbent strength and reduces penetration depth of analytes into the staged columns 161 through 163, which can further support reduced breakthrough of very volatile compounds while enabling efficient subsequent desorption.

In some embodiments, when the available headspace volume of a sample vial 322 is limited, extraction is performed based on time under vacuum for a given time rather than on measured flow volume. For example, a flow control device 142 may be opened to maximize vacuum at the sample vial 322 using vacuum pump 172 capable of reaching about 0.1 psi absolute or better. In this mode, matrix vapor formation and associated analyte transfer can continue over a selected time interval, optionally while controlling sample temperature and/or controlling a vacuum setpoint to improve run-to-run repeatability. In addition, if a vacuum is being pulled only on a water sample, the water can only achieve a vacuum of 0.35 psia at 25 ° C. before the water will condense, eliminating any decrease in the vacuum.

The above-described moisture management techniques can provide one or more operational advantages in sample preparation for GCMS analysis. In some implementations, small vials with minimal headspace can be used to reduce introduction of room air and associated contamination while still enabling extraction and concentration of analytes via vacuum-driven matrix vapor transfer. In some implementations, water management may be improved relative to packed trap techniques, including approaches that reduce water delivered to the GCMS and thereby can reduce impacts on column lifetime, instrument maintenance, and consistency of recovery and linearity for light-end compounds.

In some cases where samples have a non-volatile matrix such as essential oils or edible oils such as Extra Virgin Olive Oil (EVOO), sample 322 can be heated substantially higher than the multi-capillary column primary trap 160 to increase the rate of aroma, flavor, and odor compounds transmission to the gas phase and ultimately to the multi-capillary column primary trap 160. Operating in a pulsed mode first under a strong vacuum and then pulsing purge gas 325 can substantially increase transmission of the aromas, flavors, fragrances, and odor compounds to the multi-capillary column primary trap 160 for enrichment prior to GCMS analysis.

Extraction under vacuum increases evolution of compounds into the gas phase relative to non-vacuum headspace sampling approaches, enabling analytes to be extracted and concentrated in shorter times and/or with improved recovery for at least some analytes. Injection rates are increased relative to packed traps due to the use of capillary traps (e.g., multi-capillary column primary trap 160 and optional multi-capillary column focusing trap 180), which can enable reduced splitting or no splitting while still obtaining sufficiently narrow peak widths on a capillary GC column 360. The multi-capillary column primary trap 160 and optional multi-capillary column focusing trap 180 provide increased durability and extended time between trap replacement, including due to reduced susceptibility to damage associated with repeated desorption cycles by operating at lower desorption temperatures.

The headspace extraction interface is simplified by operating in a mode in which no purge gas is introduced into the sample vial 322, with volatilized matrix vapor serving as a carrier gas that sweeps analytes to the multi-capillary column primary trap 160. The apparatus can avoid use of a purge gas line to the sample vial 322 and can reduce concerns regarding background chemicals in the purge gas. Additionally, the pressure gradient between the sample vial 322 and the trap reduces water vapor density along the flow path, permitting the sample to be heated to increase extraction rate while maintaining trapping strength by operating the trap at a lower temperature without condensing water in the trap.

Therefore, according to the above, some embodiments are directed to a sample-preparation system for concentrating volatile compounds from an aqueous sample contained in a sealed sample vial for subsequent gas chromatography/mass spectrometry (GCMS) analysis, the system comprising a transfer port configured to receive the sealed sample vial; a sparge vessel having an outlet configured to deliver a gas stream comprising volatile compounds to a trap flow path; a vial interface configured to couple to the sealed sample vial retained in the transfer port, the vial interface including a gas-in needle and a liquid-out needle arranged to pierce a septum of the sealed sample vial, the liquid-out needle being fluidly coupled to the sparge vessel to transfer liquid from the sealed sample vial to the sparge vessel; a pressurized reservoir configured to contain a pressurized gas charge, the pressurized reservoir being fluidly coupled to the gas-in needle through an isolation valve, the isolation valve being actuatable to the pressurized gas charge into the sealed sample vial to drive liquid through the liquid-out needle into the sparge vessel; a pressure sensor fluidly coupled to the pressurized reservoir and configured to provide a pressure indication usable to detect completion of the liquid transfer based on a pressure change associated with a transition to gas flow through the liquid-out needle; and a multi-capillary column primary trap disposed along the trap flow path downstream of the sparge vessel outlet, the multi-capillary column primary trap comprising a plurality of serial open tubular capillary column sections having increasing sorbent strength and being configured to retain volatile compounds delivered from the sparge vessel outlet.

Additionally or alternatively, in some embodiments, the system includes a gas manifold including a plurality of gas inlets and a vacuum valve, wherein the gas manifold is coupled to the pressurized reservoir and configured to direct a combination of gas from the plurality of gas inlets into the pressurized reservoir. Directing a combination of gas into the pressurized reservoir enables wide concentration range of calibration standard to be added with little solvent and optimizes consistency of total gas added to push the water as rapidly as possible to the sparge vessel. Additionally or alternatively, in some embodiments the plurality of gas inlets includes a low concentration calibration standard inlet coupled to a low concentration calibration gas, and a high concentration calibration standard inlet coupled to a high concentration calibration gas. Additionally or alternatively, in some embodiments the pressure sensor is configured to measure a partial pressure of gas introduced to the pressurized reservoir from the plurality of gas inlets of the gas manifold. Measuring the partial pressure of gas introduced to the pressurized reservoir from the plurality of gas inlets of the gas manifold enables adding calibration standards over a range of concentrations to avoid adding interfering levels of solvents associated with liquid standard addition. Additionally or alternatively, in some embodiments, the system includes a volume measurement reservoir coupled to an outlet of the multi-capillary column primary trap through one or more valves; and a vacuum pump configured to apply a vacuum to the volume measurement reservoir. Additionally or alternatively, in some embodiments the system includes a pressure sensor coupled to the volume measurement reservoir, wherein the pressure sensor is configured to measure a change in pressure in the volume measurement reservoir to determine a quantity of gas flowing through the multi-capillary column primary trap. Additionally or alternatively, in some embodiments the vacuum pump is configured to apply a second vacuum to the multi-capillary column primary trap, wherein the second vacuum is stronger at an outlet of the multi-capillary column primary trap coupled to the volume measurement reservoir and the second vacuum is weaker at an inlet of the multi-capillary column primary trap coupled to an outlet of the sparge vessel. Additionally or alternatively, in some embodiments the system includes a plate disposed at a bottom of the sparge vessel, the plate including a plurality of holes in an outer portion of the plate; and tubing coupled to a gas and configured to deliver the gas through the holes in the outer portion of the plate into the sparge vessel. This approach circulates the water past the heater, thereby more efficiently bringing the heated liquid to the surface where volatile chemicals can more rapidly enter the gas phase. Also, this approach eliminates the need for a fritted sparger, glass or stainless, that are known to have internal pockets of dead volume. Additionally or alternatively, in some embodiments the system includes a waste container coupled to a bottom of the sparge vessel and a vacuum valve coupled to the bottom of the sparge vessel, wherein the waste container is configured to collect water removed from the sparge vessel after sparging, and the vacuum valve is configured to couple a vacuum to the sparge vessel after water removal. Additionally or alternatively, in some embodiments the system includes a multi-capillary column focusing trap disposed along the trap flow path downstream of the multi-capillary column primary trap comprising a second plurality of serial open tubular capillary column sections having increasing sorbent strength and shorter lengths than lengths of the serial open tubular capillary column sections of the multi-capillary column primary trap, wherein the multi-capillary column focusing trap is configured to focus volatile compounds delivered from the multi-capillary column primary trap. Additionally or alternatively, in some embodiments the system includes a split port configured to split a portion of volatile compounds desorbed from the multi-capillary column primary trap into a GCMS analyzer.

Some embodiments are directed to a method for concentrating volatile compounds from an aqueous sample contained in a sealed sample vial for subsequent GCMS analysis, the method comprising: preparing a pressurized reservoir by evacuating the pressurized reservoir and adding, to the pressurized reservoir, at least one gas-phase standard based on a pressure indication from a pressure sensor fluidly coupled to the pressurized reservoir; coupling the sealed sample vial to a transfer port and piercing a septum of the sealed sample vial with a gas-in needle and a liquid-out needle, the liquid-out needle being fluidly coupled to a sparge vessel; opening an isolation valve between the pressurized reservoir and the gas-in needle to admit at least a portion of the pressurized reservoir into the sealed sample vial to drive liquid from the sealed sample vial through the liquid-out needle into the sparge vessel; detecting completion of the liquid transfer based on a pressure change measured by the pressure sensor; delivering a gas stream from an outlet of the sparge vessel to a multi-capillary column primary trap comprising a plurality of serial open tubular capillary column sections having increasing sorbent strength to retain volatile compounds; and injecting retained volatile compounds to a GCMS.

Additionally or alternatively, in some embodiments evacuating the pressurized reservoir when preparing the pressurized reservoir includes applying a vacuum to the pressurized reservoir through a gas manifold, wherein the gas manifold includes a plurality of gas inlets including an inlet coupled to the at least one gas-phase standard. Additionally or alternatively, in some embodiments the method includes measuring a quantity of gas flowing through the multi-capillary column primary trap using a volume measurement reservoir coupled to an outlet of the multi-capillary column primary trap through one or more valves. Additionally or alternatively, in some embodiments the method includes applying a vacuum to the multi-capillary column primary trap to reduce moisture condensation in the multi-capillary column primary trap, wherein the vacuum is stronger at the outlet of the multi-capillary column primary trap coupled to the volume measurement reservoir and the vacuum is weaker at an inlet of the multi-capillary column primary trap coupled to an outlet of the sparge vessel, the vacuum is stronger at the inlet of the multi-capillary column primary trap and weaker at the sparge vessel, and the vacuum is stronger at the sparge vessel and weaker at the sample vial. Additionally or alternatively, in some embodiments the method includes delivering a gas into the sparge vessel through tubing coupled to the gas and to a plate disposed at a bottom of the sparge vessel, the plate including a plurality of holes in an outer portion of the plate to carry heat from a heater on the outside of the sparge vessel to improve transfer of volatile chemicals to the gas phase at a water/partial vacuum boundary. Additionally or alternatively, in some embodiments the method includes collecting water removed from the sparge vessel after sparging in a waste container coupled to a bottom of the sparge vessel; and drawing a vacuum in the sparge vessel using a vacuum valve coupled to the bottom of the sparge vessel after removing the water. Additionally or alternatively, in some embodiments the method includes focusing volatile compounds delivered from the multi-capillary column primary trap using a multi-capillary column focusing trap disposed along a trap flow path downstream of the multi-capillary column primary trap comprising a second plurality of serial open tubular capillary column sections having increasing sorbent strength and shorter column lengths than column lengths of the plurality of serial open tubular capillary column sections of the multi-capillary column primary trap. Additionally or alternatively, in some embodiments the method includes splitting a portion of volatile compounds desorbed from the multi-capillary column primary trap into a GCMS analyzer.

Some embodiments are directed to a vacuum headspace extraction system for preparing volatile compounds for analysis by a gas chromatograph coupled to a mass spectrometer (GCMS), the system comprising: a vial interface configured to pneumatically couple to a sample vial via a leak-tight seal such that a headspace of the sample vial is placed in fluid communication with a transfer line; a multi-capillary column primary trap fluidly coupled to receive a vapor stream via a primary trap inlet, the multi-capillary column primary trap comprising a plurality of open tubular capillary columns having increasing sorbent strength arranged to retain volatile compounds from the vapor stream; and a vacuum source fluidly coupled to an outlet of the multi-capillary column primary trap and configured to apply vacuum such that volatilized matrix vapor from a sample in the sample vial sweeps volatile compounds from the sample vial, through the transfer line and the multi-capillary column primary trap, without introducing purge gas into the sample vial. Additionally or alternatively, in some embodiments, the system includes a volume measurement reservoir coupled to an outlet of the multi-capillary column primary trap, to the vacuum source, and to a pressure sensor configured to measure increases in pressure in the volume measurement reservoir to monitor flow rates through the multi-capillary column primary trap. Additionally or alternatively, in some embodiments the system includes further comprising a flow control device coupled to an outlet of the multi-capillary column primary trap. Additionally or alternatively, in some embodiments the system includes a heater configured to apply heat to the sample vial to volatilize one or more sample compounds. The heater provides additional moisture management and/or increasing transport of compounds out of the matrix by increasing the temperature of the sample above that of the multi-capillary column primary trap, taking advantage of an increase in vacuum between the sample headspace and the multi-capillary column primary trap. Additionally or alternatively, in some embodiments the vacuum source is configured to apply the vacuum for a selected period of time in a time under vacuum extraction mode of the system. Additionally or alternatively, in some embodiments the system includes a valve configured to apply the purge gas to the multi-capillary column primary trap in pulses through the sample vial to sweep one or more chemicals through the multi-capillary column primary trap. Adding purge gas at the outlet of the vial to complete transfer of heavier compounds to the multi-capillary column primary trap allows additional moisture transmission rate control by operating the transfer line at an initial temperature below that of the sample. Additionally or alternatively, in some embodiments the system includes a multi-capillary column focusing trap disposed along a trap flow path downstream of the multi-capillary column primary trap comprising a second plurality of serial open tubular capillary columns having increasing sorbent strength and being configured to focus volatile compounds delivered from the multi-capillary column primary trap. Additionally or alternatively, in some embodiments the system includes a split port configured to split a portion of volatile compounds desorbed from the multi-capillary column primary trap into a GCMS analyzer.

Some embodiments are directed to a method for preparing volatile compounds for analysis by a gas chromatograph coupled to a mass spectrometer (GCMS), the method comprising: pneumatically coupling a sample vial to a leak-tight seal such that a headspace of the sample vial is placed in fluid communication with a transfer line; applying vacuum with a vacuum source such that volatilized matrix vapor from a sample in the sample vial sweeps volatile compounds from the sample vial, through the transfer line, and to a multi-capillary column primary trap without introducing purge gas into the sample vial; and retaining at least a portion of the volatile compounds on the multi-capillary column primary trap, the multi-capillary column primary trap comprising a plurality of open tubular capillary columns having increasing sorbent strength. Additionally or alternatively, in some embodiments the method includes applying, with a heater, heat to the sample vial to volatilize one or more sample compounds. Additionally or alternatively, in some embodiments the vacuum source is configured to apply the vacuum for a selected period of time in a time under vacuum extraction mode. Additionally or alternatively, in some embodiments the method includes applying the purge gas to the multi-capillary column primary trap. Additionally or alternatively, in some embodiments the method includes focusing volatile compounds delivered from the multi-capillary column primary trap using a multi-capillary column focusing trap disposed along a trap flow path downstream of the multi-capillary column primary trap comprising a second plurality of serial open tubular capillary columns having increasing sorbent strength. Additionally or alternatively, in some embodiments the method includes splitting a portion of volatile compounds desorbed from the multi-capillary column primary trap into a GCMS analyzer.

1. A vacuum headspace extraction system for preparing volatile compounds for analysis by a gas chromatograph coupled to a mass spectrometer (GCMS), the system comprising:
a vial interface configured to pneumatically couple to a sample vial via a leak-tight seal such that a headspace of the sample vial is placed in fluid communication with a transfer line;
a multi-capillary column primary trap fluidly coupled to receive a vapor stream via a primary trap inlet, the multi-capillary column primary trap comprising a plurality of open tubular capillary columns having increasing sorbent strength arranged to retain volatile compounds from the vapor stream; and
a vacuum source fluidly coupled to an outlet of the multi-capillary column primary trap and configured to apply vacuum such that volatilized matrix vapor from a sample in the sample vial sweeps volatile compounds from the sample vial, through the transfer line and the multi-capillary column primary trap, without introducing purge gas into the sample vial.

2. The system of claim 1,
a volume measurement reservoir coupled to an outlet of the multi-capillary column primary trap, to the vacuum source, and to a pressure sensor configured to measure increases in pressure in the volume measurement reservoir to monitor flow rates through the multi-capillary column primary trap.

3. The system of claim 1, further comprising a flow control device coupled to an outlet of the multi-capillary column primary trap.

4. The system of claim 1, further comprising a heater configured to apply heat to the sample vial to volatilize one or more sample compounds.

5. The system of claim 1, wherein the vacuum source is configured to apply the vacuum for a selected period of time in a time under vacuum extraction mode of the system.

6. The system of claim 1, further comprising a valve configured to apply the purge gas to the multi-capillary column primary trap in pulses through the sample vial to sweep one or more chemicals through the multi-capillary column primary trap.

7. The system of claim 1, further comprising a multi-capillary column focusing trap disposed along a trap flow path downstream of the multi-capillary column primary trap comprising a second plurality of serial open tubular capillary columns having increasing sorbent strength and being configured to focus volatile compounds delivered from the multi-capillary column primary trap.

8. The system of claim 1, further comprising a split port configured to split a portion of volatile compounds desorbed from the multi-capillary column primary trap into a GCMS analyzer.

9. A method for preparing volatile compounds for analysis by a gas chromatograph coupled to a mass spectrometer (GCMS), the method comprising:
pneumatically coupling a sample vial to a leak-tight seal such that a headspace of the sample vial is placed in fluid communication with a transfer line;
applying vacuum with a vacuum source such that volatilized matrix vapor from a sample in the sample vial sweeps volatile compounds from the sample vial, through the transfer line, and to a multi-capillary column primary trap without introducing purge gas into the sample vial; and
retaining at least a portion of the volatile compounds on the multi-capillary column primary trap, the multi-capillary column primary trap comprising a plurality of open tubular capillary columns having increasing sorbent strength.

10. The method of claim 9, further comprising applying, with a heater, heat to the sample vial to volatilize one or more sample compounds.

11. The method of claim 9, wherein the vacuum source is configured to apply the vacuum for a selected period of time in a time under vacuum extraction mode.

12. The method of claim 9, further comprising applying the purge gas to the multi-capillary column primary trap.

13. The method of claim 9, further comprising:
focusing volatile compounds delivered from the multi-capillary column primary trap using a multi-capillary column focusing trap disposed along a trap flow path downstream of the multi-capillary column primary trap comprising a second plurality of serial open tubular capillary columns having increasing sorbent strength.

14. The method of claim 9, further comprising splitting a portion of volatile compounds desorbed from the multi-capillary column primary trap into a GCMS analyzer.
